(19) United States
(12) Patent Application Publication
(10) Pub. No.: US 2015/0125846 A1
(43) Pub. Date: May 7, 2015

(54) Rollable and Transportable Dry Erase Board

(71) Applicant: Michael Langford, Kaneohe, HI (US)

(72) Inventor: Michael Langford, Kaneohe, HI (US)

(21) Appl. No.: 14/488,583

(22) Filed: Sep. 17, 2014

Related U.S. Application Data
(60) Provisional application No. 61/900,164, filed on Nov. 5, 2013.

(51) Int. Cl. B43L 1/00; G09F 21/02

(52) U.S. Cl. CPC B43L 1/00; G09F 21/02
USPC 434/408

(57) ABSTRACT

A rollable writing surface is provided that provides a user with a mobile whiteboard surface upon which a dry erase marker can be used to create written signs or to provide a personal writing surface. The writing surface comprises a backside layer of elastomeric material, preferably a rubberized material that is biased to remain flat, while thereover is a whiteboard substrate material that forms the writing surface. Over the substrate layer is a dry erase coating that is disposed along the exposed outer surface of substrate layer. The dry erase coating is substantially non-porous and supports dry erase markings without staining or permanently supporting the ink. The flexibility of the assembly allows the same to be rolled into a compact form and deployed, whereafter the assembly lies substantially flat for use as a writing surface using dry erase markers.

### CROSS REFERENCE TO RELATED APPLICATION

This application claims the benefit of U.S. Provisional Application No. 61/900,164 filed on Nov. 5, 2013. The above identified patent application is herein incorporated by reference in its entirety to provide continuity of disclosure.

### BACKGROUND OF THE INVENTION

1. Field of the Invention

The present invention relates to message boards and writing surfaces. More specifically, the present invention relates to a transportable writing surface that utilizes a flexible dry erase writing surface that can be rolled into a tight form and transported to a desired location and written upon using dry erase markers.

Displaying signs and message boards while at an event is a common activity, particularly at sporting events or political events. Patrons hold up signs that display a desired message, sometimes in support of an idea or specific team, or in opposition thereto. For those among this contingent, the ability to update a message without replacing the message board or reconstructing a new message board assembly is an asset, and an object in which the present invention is adapted to provide.

Similar to large message boards, another common need for a writing surface in outdoor spaces occurs during instructional events or coaching sessions. Athletic coaches and educators may wish to diagram a concept or a specific play using a writing surface that can be readily updated and reused. Typically a small whiteboard assembly in the form of a clipboard is used; however carrying this rigid object is not always convenient. Furthermore the size of these types of writing surfaces is generally limited to the size of a clipboard or legal pad, which can be less than what the user desires or needs for the specific situation.

The present invention discloses a deployable writing surface that includes a dry erase surface and a backing layer that allows the assembly to be rolled into a tight form and stored within a carriage tube or by way of a temporary strap fastener. The assembly comprises a layer that is a low density rubber or other elastomeric material that has a flat shape and a construction that is biased to remain flat even after being flexed or formed into a roll. The upper surface thereof comprises a coating of dry erase material that allows the user to write thereon with dry erase markers. The backside of the device may include magnetic fasteners to secure the assembly to a wall or similar surface. Overall, the device eliminates the need for users to carry rigid, bulky dry-erase boards when desired, and provides a readily transportable writing surface that can be stowed in rolled form

2. Description of the Prior Art

Devices have been disclosed in the prior art that relate to writing surfaces and dry erase boards. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 7,758,348 to Key, which discloses a writing surface that comprises a flexible work support and a plurality of material layers attached to the work support. The material layers are statically attached to one another in a stack and each comprise a static cling material and an outer surface with a coating to support erasable marking. The Key device provides a plurality of writing surfaces for use in a classroom or office setting. However, the Key device fails to contemplate the structure or function of the present invention, which is to provide a pliable dry erase surface for a user to transport to a location and unravel to deploy a given message, wherein the message can be updated and tailored to a given event.

Another device is U.S. Patent Publication No. 2012/0129146 to Wijerama, which discloses an erasable writing panel that is adapted to form a cover for a binder or a notebook/notepad. The cover includes a transparent sheet against a substrate, whereby pressing against the transparent sheet using a writing utensil or stylus causes darkening thereof when pressed against the substrate. This allows shapes and markings to be made, which can then be erased by separating the sheet and the substrate. While the Wijerama provides a unique writing surface that allows for erasable media, it fails to contemplate a dry erase structure that is rollable and pliable such that the user can transport relative large sheets thereof and then deploy the sheet at a desired location and write on the dry erase surface provided.

Finally, U.S. Pat. No. 7,399,184 to Hester discloses a display article that comprises a flexible substrate that forms a writing surface capable of being used as a dry erase surface. The surface comprises an outer edge with a frame, whereby an attachment is provided for mounting the surface to a wall. The attachments are hook and loop style or adhesive. While the Hester device contemplates a dry erase board with flexibility, it fails to contemplate a backside material surface that is biased to remain flat as provided herein. Furthermore the present invention does not contemplate nor desire a border used to frame the surface.

The present invention provides a rollable surface upon which a user can apply dry erase markings to temporarily create signs or to use the compact surface as a writing pad. The assembly comprises a backside layer that is biased to remain flat, yet is flexible to accommodate a rolled form. Over the backside layer is a flexible layer that supports a whiteboard substrate layer, which is coated with an outer layer of dry erase coating that supports dry erase markers and erasers.

It is submitted that the present invention is substantially divergent in design elements from the prior art, and consequently it is clear that there is a need in the art for an improvement to existing writing surface devices. The present invention provides a rollable and readily transportable writing surface specific to dry erase markers, whereby a user can deploy the sign at various events or during certain environments in which signage or visual presentation is necessary. In this regard the instant invention substantially fulfills these needs.

### SUMMARY OF THE INVENTION

In view of the foregoing disadvantages inherent in the known types of writing surfaces now present in the prior art, the present invention provides a new, rollable writing surface that can be utilized for providing convenience for the user when a dry erase writing surface is desired in a remote location where a rigid writing surface would be inappropriate or not practical.

It is therefore an object of the present invention to provide a new and improved writing surface assembly that has all of the advantages of the prior art and none of the disadvantages.

It is another object of the present invention to provide a writing surface assembly that has a construction that supports being stored in a compact, rolled state, and thereafter support being deployed in a substantially planar configuration when used as a writing surface or display.

Another object of the present invention is to provide a writing surface assembly that includes a backside material layer that is flexible, yet biased to remain flat, whereby the natural state of the assembly is a planar configuration, but the flexibility of the assembly supports a rolled, compact state for ease of transport.

Yet another object of the present invention is to provide a writing surface assembly is a whiteboard substrate comprising a material layer that can be rolled and support an exterior dry erase coating, whereby the coating allows a dry erase marker to apply markings thereto without staining or otherwise permanently marking the coating or substrate.

Another object of the present invention is to provide a writing surface assembly that supports fasteners along the backside surface thereof, whereby the device can be supported from a support or another surface without the user manually supporting the same.

A final object of the present invention is to provide a writing surface assembly that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a cross section side view of the present invention.

FIG. 2 shows an illustrative view of one embodiment of the present invention being transitioned between a planar state and a rolled state.

FIG. 3 shows an illustrative view of another embodiment of the present invention being transitioned between a planar state and a rolled state.

FIG. 4 shows a view of the versatility of the device when in a rolled state, wherein the assembly can be transported or stowed within a backpack or storage container.

FIG. 5 shows an illustrative view of the device in a planar state, whereby the assembly is used as a sign after a message is placed thereon using dry erase markers.

### DETAILED DESCRIPTION OF THE INVENTION

Reference is made herein to the attached drawings. Like reference numerals are used throughout the drawings to depict like or similar elements of the writing surface assembly of the present invention. For the purposes of presenting a brief and clear description of the present invention, the preferred embodiment will be discussed as used for providing a readily transportable writing surface that supports dry erase markings without permanent marking thereof. The figures are intended for representative purposes only and should not be considered to be limiting in any respect.

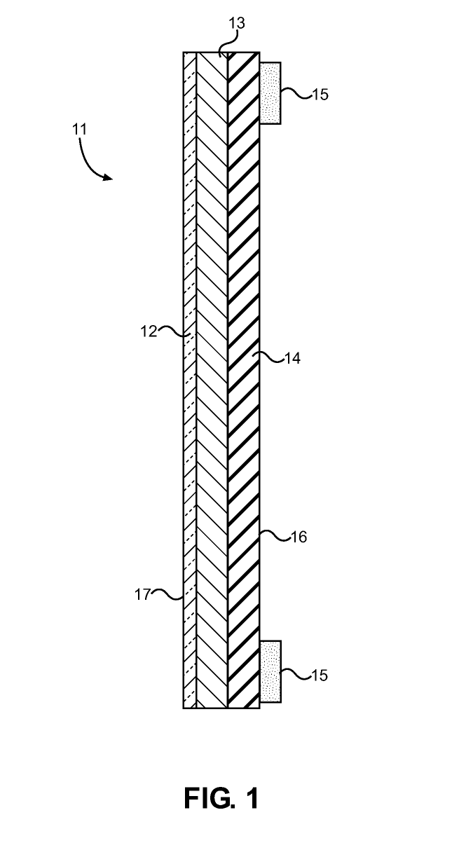

Referring now to FIG. 1, there is shown a cross section side view of the writing surface assembly 11 of the present invention. The writing surface 11 is an elongated planar writing surface comprising an outer writing surface, a backside surface, and one or more perimeter edges forming the outer edge of the assembly. The writing surface 11 is comprised of several layers that allow the outer surface 17 to support dry erase markings and lay in a substantially planar writing surface when deployed, while also allowing the assembly to be readily condensed into a rolled form for transport. The backside layer 14 comprises a thickened, elastomeric material that is naturally biased to remain planar. This backside layer is affixed to a whiteboard substrate layer 13 that supports an outer surface layer 12 of dry erase coating material.

The backside layer 14 comprises a rubberized or similar elastomeric material that remains planar in a rest state, and can readily be rolled into a more compact form. In a similar construction to a computer mouse pad, the backside layer is thicker than the whiteboard substrate 13 or coating layers 12, and forms the majority of the assembly construction. In this way, the backside layer 14 allows the assembly to be deployed and readily deployed without trying to flatten out the writing surface into a planar state, which is generally otherwise required when using cardboard or poster board signage.

The whiteboard substrate layer 13 comprises a paper or laminate material that is flexible and can be manipulated into a rolled form without creasing or bending. The substrate layer 13 is coated with an outer dry erase coating 12 that allows a dry erase marker to be used along the outer surface 17 of the assembly without permanently marking the same. The dry erase coating 12 comprises a polyester or acrylic coating, or alternatively a high gloss paint that is non-porous and supports dry erase markers without absorbing and permanently supporting the dry erase ink. The assembly is adapted to be written upon by a dry erase marking, which applies ink to the dry erase coating layer 12 for signage or for a writing pad, whereafter a whiteboard eraser or another appliance can wipe the coating layer 12 clean of any markings.

Along the backside surface of the assembly is at least one fastener 15, whereby fasteners 15 allow the assembly to be supported against a wall or another support surface and not necessarily be handheld. The fasteners 15 are preferably a magnetic material or an adhesive, whereby the fastener 15 allows the assembly to be supported against a ferric surface or another surface while in a planar state. This is useful when using the writing assembly as a standard whiteboard, or when deploying the assembly as a poster or sign along a vertical surface.

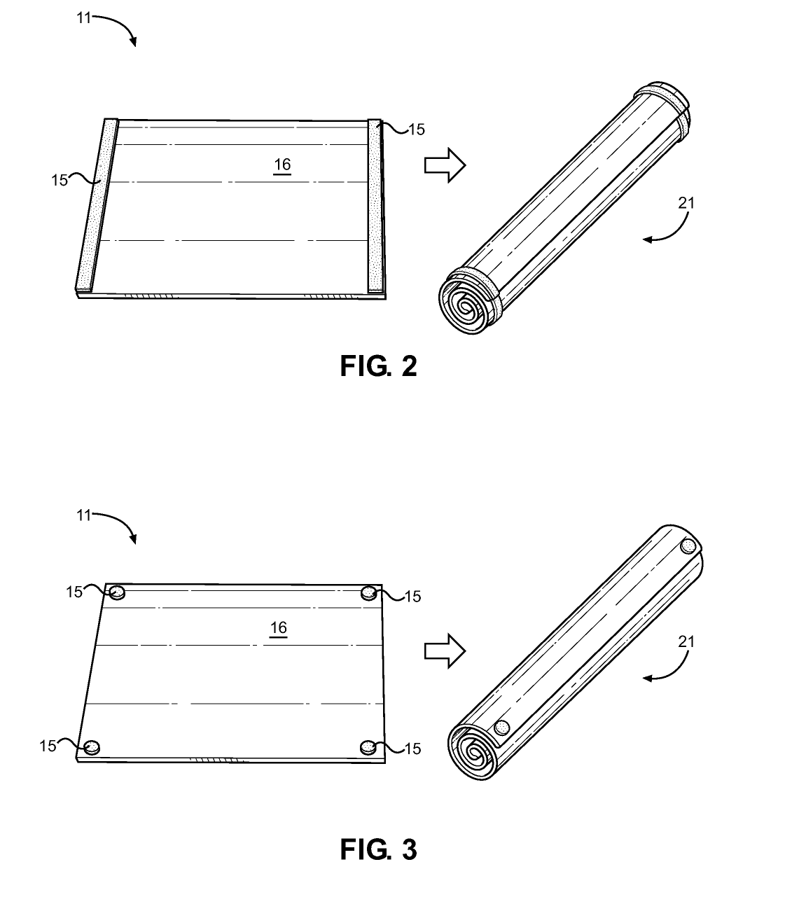

Referring now to FIGS. 2 and 3, there are shown view of the present invention in both a planar state and a rolled state 21. The assembly 11 of the present invention is flexible and can be rolled from one edge to the other without kinking, bending or folding in the process. The backside layer is of sufficient thickness and elasticity that the writing substrate does not bend or become damaged when rolled. When in a rolled state 21, the assembly can be stowed within a storage container or travel bag and taken to a remote location that may not otherwise be appropriate for a rigid whiteboard or poster board. This includes sporting events, demonstrations, educational events, coaching events, and other environments in which a sign, display or writing surface is required.

Also shown in FIGS. 2 and 3 are two embodiments of the fasteners 15 disposed along the backside surface 16 of the assembly. In one embodiment, the fasteners are elongated strips disposed along the backside surface. In another contemplated embodiment, the fasteners are discrete tabs disposed on the corners and along the backside of the assembly. It is not desired to limit the exact configuration of the fasteners or their structure, but rather to disclose examples of fasteners capable of supporting the assembly from vertical surface when in a planar state.

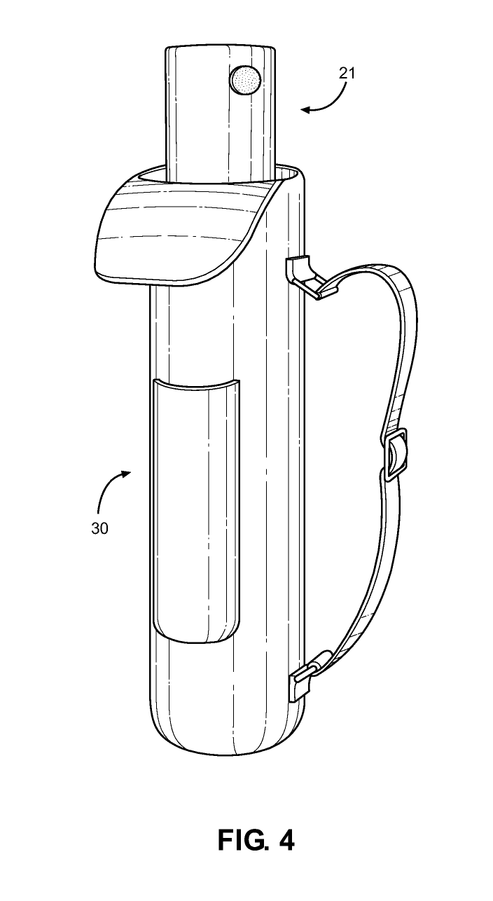

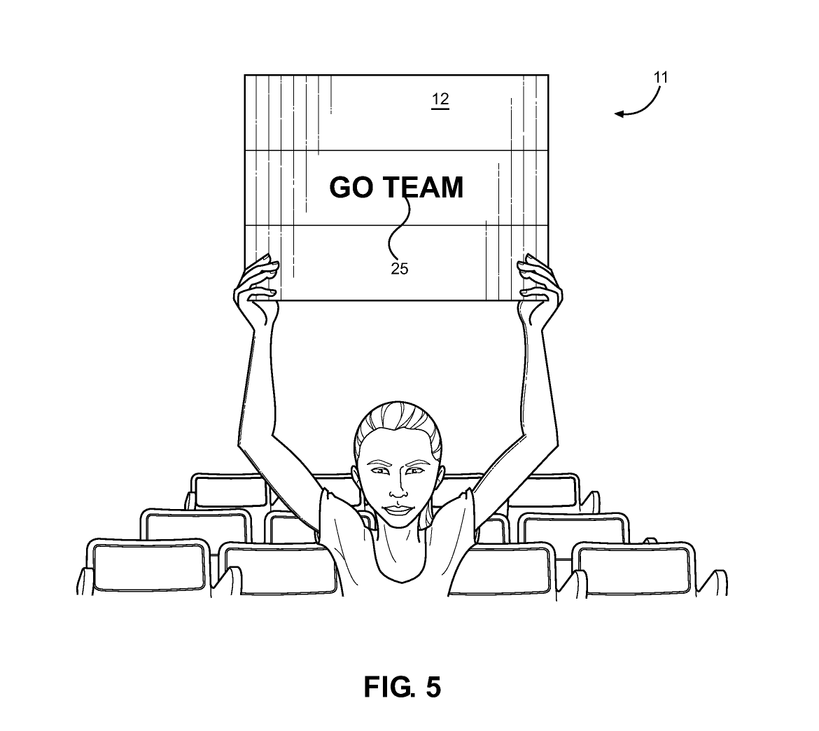

Referring now to FIGS. 4 and 5, there are show two views of the present invention in a working state. FIG. 4 illustrates the present invention in a rolled state 21, wherein the versatility and transportability of the assembly is highlighted. The structure of the present invention supports a rolled state 21 without bending or damaging the substrate layer or the outer dry erase coating. This allows a user to roll the assembly and stow the assembly in a transport case 30 or similar storage container. The user can then transport the assembly to a desired location, after which the assembly returns to a substantially flattened state.

FIG. 5 provides an illustrative view of one potential use of the present invention, notably for creating temporary signage during an event. Since the outer writing surface 12 is one that supports dry erase markers, the exact message or marking 25 placed on the surface 12 can be tailored for a given event. This includes supporting teams and players in an athletic competition, voicing protest or support during a rally or gathering, or alternatively providing the user with a writing surface upon which to sketch ideas or plans while in a given environment. Because the assembly can be rolled, transported, and thereafter deployed in a substantially planar state, the assembly provides a necessary replacement for poster board material, clipboards, and other writing surfaces that are substantially rigid and planar. The present invention is more transportable and stows in a more condensed shape, while poster board or signage material is generally larger or not as easily carried or transported.

Dry erase boards are popular tools that are used by a large number of people for a large number of tasks, including for personal use or for projecting a message to others. Because most of these boards are rigid or quick large, it can be difficult to carry the board or transport it to an event. Furthermore, to display the board, individuals are required to carry around a stand or an easel, which is not only inconvenient, but also highly impractical. The present invention describes a rollable dry erase writing surface assembly. The assembly mimics a dry erase board, but can be rolled into a condensed state when not in use. The backside layer comprises a rubber, elastomeric, or any flexible and elastic material that can be rolled and then return to its original state once unraveled. The assembly provides individuals with a convenient and portable writing surface. This eliminates the need for users to carry hard, bulky dry-erase boards, and additionally allows individuals to support the assembly from a support surface using the backside fasteners. Overall, the present invention provides a unique writing surface that addresses several issues in the art.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A rollable and flexible dry erase writing surface, comprising:
an elongated planar writing surface comprising an outer writing surface, a backside surface, and one or more perimeter edges;
said planar writing surface comprising a backside layer, a whiteboard substrate layer, and an outer dry erase coating layer;
said backside layer comprising an elastic material that can be condensed into a rolled state without bending and is biased to return to a planar state when unraveled;
said outer dry erase coating layer comprising a coating that removably supports dry erase markings on said outer writing surface without permanently marking outer writing surface.

2) The rollable and flexible dry erase writing surface of claim 1, wherein said backside layer comprises an elastomeric material.

3) The rollable and flexible dry erase writing surface of claim 1, wherein said outer dry erase coating layer comprises a polyester coating that is substantially non-porous and supports dry erase markings without absorbing and permanently supporting ink therefrom.

4) The rollable and flexible dry erase writing surface of claim 1, wherein said outer dry erase coating layer comprises an acrylic coating that is substantially non-porous and supports dry erase markings without absorbing and permanently supporting ink therefrom.

5) The rollable and flexible dry erase writing surface of claim 1, wherein said outer dry erase coating layer comprises a high gloss paint that is substantially non-porous and supports dry erase markings without absorbing and permanently supporting ink therefrom.
